(19) United States
(12) Patent Application Publication
(10) Pub. No.: US 2026/0032689 A1
(43) Pub. Date: Jan. 29, 2026

(54) CONTROL RESOURCE SET CONFIGURATION AND SELECTION BASED ON SLOT TYPE INDICATION IN SUBBAND NON-OVERLAPPING FULL DUPLEX

(71) Applicant: Nokia Technologies Oy, Espoo (FI)

(72) Inventors: Claudio ROSA, Randers NV (DK); Karri Markus RANTA-AHO, Espoo (FI); Guillermo POCOVI, Aalborg (DK); Klaus Ingemann PEDERSEN, Aalborg (DK)

(73) Assignee: Nokia Technologies Oy, Espoo (FI)

(21) Appl. No.: 18/881,471

(22) PCT Filed: Jul. 7, 2022
(86) PCT No.: PCT/US2022/036425

§ 371 Date: Jan. 6, 2025

(51) Int. Cl. H04W 72/23

(52) U.S. Cl. CPC H04W 72/23

(57) ABSTRACT

Systems, methods, apparatuses, and computer program products for enhancing dynamic CORESET adaptation with limited or no control channel overhead. One method may include receiving, by a UE, a plurality of PDCCH CORESET configurations associated with at least one SS; determining, by the UE, at least one of the PDCCH CORESET configurations is associated with a symbol or slot format from a corresponding set of symbols; and performing, by the UE, PDCCH monitoring on an active control resource set configuration associated with the set of determined slots or symbols.

### TECHNICAL FIELD

Some example embodiments may generally relate to mobile or wireless telecommunication systems, such as Long Term Evolution (LTE), fifth generation (5G) radio access technology (RAT), new radio (NR) access technology, sixth generation (6G), and/or other communications systems. For example, certain example embodiments may relate to systems and/or methods for enhancing dynamic control resource set (CORESET) adaptation with limited or no control channel overhead.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (UE) (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment, a plurality of physical downlink control channel control resource set configurations associated with at least one search space. The method may further include determining, by the user equipment, at least one of the physical downlink control channel control resource set configurations is associated with a symbol or slot format from a corresponding set of symbols. The method may further include performing, by the user equipment, physical downlink control channel monitoring on an active control resource set configuration associated with the set of determined slots or symbols.

In accordance with certain example embodiments, an apparatus may include means for receiving a plurality of physical downlink control channel control resource set configurations associated with at least one search space. The apparatus may further include means for determining at least one of the physical downlink control channel control resource set configurations is associated with a symbol or slot format from a corresponding set of symbols. The apparatus may further include means for performing physical downlink control channel monitoring on an active control resource set configuration associated with the set of determined slots or symbols.

In accordance with various example embodiments, a non-transitory computer readable medium may be encoded with instructions that may, when executed in hardware, perform a method. The method may include receiving a plurality of physical downlink control channel control resource set configurations associated with at least one search space. The method may further include determining at least one of the physical downlink control channel control resource set configurations is associated with a symbol or slot format from a corresponding set of symbols. The method may further include performing physical downlink control channel monitoring on an active control resource set configuration associated with the set of determined slots or symbols.

In accordance with some example embodiments, a computer program product may perform a method. The method may include receiving a plurality of physical downlink control channel control resource set configurations associated with at least one search space. The method may further include determining at least one of the physical downlink control channel control resource set configurations is associated with a symbol or slot format from a corresponding set of symbols. The method may further include performing physical downlink control channel monitoring on an active control resource set configuration associated with the set of determined slots or symbols.

In accordance with certain example embodiments, an apparatus may include at least one processor and at least one memory including computer program code. The at least one memory and the computer program code may be configured to, with the at least one processor, cause the apparatus to at least receive a plurality of physical downlink control channel control resource set configurations associated with at least one search space. The at least one memory and the computer program code may be further configured to, with the at least one processor, cause the apparatus to at least determine at least one of the physical downlink control channel control resource set configurations is associated with a symbol or slot format from a corresponding set of symbols. The at least one memory and the computer program code may be further configured to, with the at least one processor, cause the apparatus to at least perform physical downlink control channel monitoring on an active control resource set configuration associated with the set of determined slots or symbols.

In accordance with various example embodiments, an apparatus may include circuitry configured to receive a plurality of physical downlink control channel control resource set configurations associated with at least one search space. The circuitry may further be configured to determine at least one of the physical downlink control channel control resource set configurations is associated with a symbol or slot format from a corresponding set of symbols. The circuitry may further be configured to perform physical downlink control channel monitoring on an active control resource set configuration associated with the set of determined slots or symbols.

In accordance with some example embodiments, a method may include transmitting, by a network entity, a plurality of physical downlink control channel control resource set configurations associated with a search space to a user equipment. The method may further include transmitting, by the network entity, control information to the user equipment on a physical downlink control channel on a set of slots or symbols and on a set of frequency resources within an active control resource set configuration.

In accordance with certain example embodiments, an apparatus may include means for transmitting a plurality of physical downlink control channel control resource set configurations associated with a search space to a user equipment. The apparatus may further include means for transmitting control information to the user equipment on a physical downlink control channel on a set of slots or symbols and on a set of frequency resources within an active control resource set configuration.

In accordance with various example embodiments, a non-transitory computer readable medium may be encoded with instructions that may, when executed in hardware, perform a method. The method may include transmitting a plurality of physical downlink control channel control resource set configurations associated with a search space to a user equipment. The method may further include transmitting control information to the user equipment on a physical downlink control channel on a set of slots or symbols and on a set of frequency resources within an active control resource set configuration.

In accordance with some example embodiments, a computer program product may perform a method. The method may include transmitting a plurality of physical downlink control channel control resource set configurations associated with a search space to a user equipment. The method may further include transmitting control information to the user equipment on a physical downlink control channel on a set of slots or symbols and on a set of frequency resources within an active control resource set configuration.

In accordance with certain example embodiments, an apparatus may include at least one processor and at least one memory including computer program code. The at least one memory and the computer program code may be configured to, with the at least one processor, cause the apparatus to at least transmit a plurality of physical downlink control channel control resource set configurations associated with a search space to a user equipment. The at least one memory and the computer program code may be further configured to, with the at least one processor, cause the apparatus to at least transmit control information to the user equipment on a physical downlink control channel on a set of slots or symbols and on a set of frequency resources within an active control resource set configuration.

In accordance with various example embodiments, an apparatus may include circuitry configured to transmit a plurality of physical downlink control channel control resource set configurations associated with a search space to a user equipment. The circuitry may further be configured to transmit control information to the user equipment on a physical downlink control channel on a set of slots or symbols and on a set of frequency resources within an active control resource set configuration.

### BRIEF DESCRIPTION OF THE DRAWINGS

For a proper understanding of example embodiments, reference should be made to the accompanying drawings, wherein:

FIG. 1 illustrates a comparison of frequency-time resource partitioning using sub-band full duplex (SBFD) with traditional frequency division duplex (FDD)/time division duplex (TDD).

FIG. 2 illustrates an example of a 14-symbol slot format (x-axis) with mixture of downlink (DL) and uplink (UL) physical resource blocks (PRBs) (y-axis), with CORESET configuration overlapping with UL/guard band resources in SBFD slots.

FIG. 3 illustrates an example of a flow diagram of a method according to various example embodiments.

FIG. 4 illustrates an example of multiple CORESET configurations (per search space) being applicable at the UE depending on the slot/symbol format (D, U, SBFD).

FIG. 5 illustrates an example of associations between CORESET, search spaces (SSs), and slot types according to various example embodiments.

FIG. 6 illustrates an example of determining valid CORESETs based on their overlap with DL-UL symbols according to some example embodiments.

FIG. 7 illustrates an example of another flow diagram of a method according to various example embodiments.

FIG. 8 illustrates an example of a signaling diagram according to certain example embodiments.

FIG. 9 illustrates an example of various network devices according to some example embodiments.

FIG. 10 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for enhancing dynamic CORESET adaptation with limited or no control channel overhead is not intended to limit the scope of certain example embodiments, but is instead representative of selected example embodiments.

3GPP NR supports two duplexing modes: FDD for paired bands, and TDD for unpaired bands. In TDD, the time domain resource is split between DL and UL. Allocation of a limited time duration for the UL in TDD could reduce coverage and capacity, and increase latency.

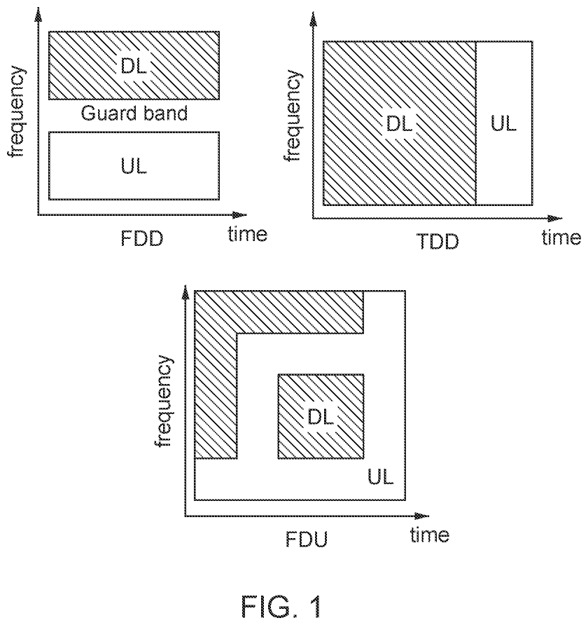

One objective of 3GPP NR in Release 18 is to study simultaneous DL transmission and UL reception on different PRBs within an unpaired, wideband NR cell, such as illustrated in FIG. 1 (i.e., SBFD). In other sources, this duplexing scheme may be referred to as a cross-division duplexing (xDD) scheme or flexible duplexing (FDU).

In 3GPP NR, the CORESET and SS configurations identify a set of physical frequency and time resources (i.e., a specific area on the NR downlink resource grid), as well as a set of parameters used to carry downlink control information (DCI) on physical downlink control channel (PDCCH) resources. The NR CORESET region may be localized to a specific region in frequency domain, and not necessarily be spread across the entire channel bandwidth, though it must be confined within the UE bandwidth part (BWP). In contrast, the CORESET configuration is quite flexible and uses a bitmap of six resource blocks (RBs) per bit to indicate which PRBs are part of the CORESET. The UE may be configured with up to three CORESETs, up to ten SSs per BWP, and a maximum of four BWPs may be supported in a serving cell. Each SS is associated with a CORESET, wherein the CORESET determines how the PDCCH monitoring is performed in frequency domain and over how many symbols it spans. At any given symbol, the UE may monitor the PDCCH candidates of one or more CORESETs under specific constraints set by the UE capabilities. Thus, the SS configuration defines when to begin PDCCH monitoring, while the associated CORESET configuration defines where to perform PDCCH monitoring in frequency domain and for how long. In addition to that, the SS configuration may also define how monitoring should be performed, such as defining the actual blind decode (BD) candidates by configuring how many BDs for a given aggregation level (AL) there are for the corresponding SS. The UE may be required to support at least 2 CORESETs in a BWP.

With SBFD operation at the base station, the portion of the cell bandwidth allocated to DL and UL may dynamically change from slot/symbol to slot/symbol, as shown in FIG. 1. However, adapting the UL and DL UE BWP to the portion of the cell bandwidth that is allocated to DL and UL in a specific slot/symbol may not be a feasible option due to BWP switch delays, as well as UEs neither being able to receive nor to transmit for at least one slot within the BWP switch delay.

While physical downlink shared channel (PDSCH) transmissions may be contained in the corresponding DL portion of the cell bandwidth (BW) by scheduling the UE in the corresponding frequency resources, adapting semi-statically allocated resources (e.g., PDCCH/CORESET configurations) may be challenging.

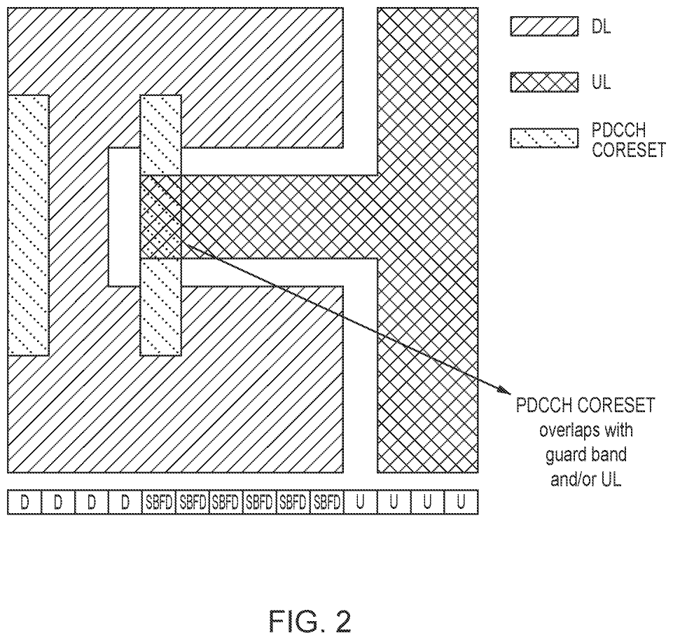

Using the slot format configuration illustrated in FIG. 2, if at any time the PDCCH CORESET overlaps with the UL subband (i.e., the part of the cell bandwidth which is allocated for UL reception) during a SBFD symbol (i.e., a symbol with PRBs allocated for both DL transmission and UL reception), some PDCCH candidates may be partially or fully on the UL subband, and may therefore be unusable. This results in increased UE power consumption and/or ineffective use of PDCCH resources, which may indirectly result in a loss of capacity.

Certain example embodiments described herein may have various benefits and/or advantages to overcome the disadvantages described above. For example, certain example embodiments may address problems described above related to varying the size of the DL subband with SBFD, specifically by focusing on enhancements enabling dynamic CORESET adaptation with limited/no control channel overhead. For example, some example embodiments may not require specific signaling to indicate to the UE to switch frequency resources where to perform PDCCH monitoring in correspondence of SBFD slots or symbols. Furthermore, scheduling flexibility for SBFD-aware UEs may be maximized, with only negligible increases in the signaling overhead. In practice, no additional field in DCI may be needed to perform dynamic switching, and only a few more information elements (IEs) in the radio resource control (RRC) configuration may be needed. In addition, the number of PDCCH blind decodes may not need to be increased compared with the configuration of two or more overlapping SS. Thus, certain example embodiments discussed below are directed to improvements in computer-related technology.

Some example embodiments described herein relate to determining frequency resources of where to perform PDCCH monitoring with SBFD operation in RRC connected mode, but may also apply to determining frequency resources of where to perform PDCCH monitoring for message (MSG)2 during initial access procedure. This would require the UE to be configured with at least one additional CORESET configuration than CORESET #0 during initial access procedure. This additional CORESET configuration may be configured, for example, via system information block (SIB)1 signaling, and/or may be used by the UE to perform PDCCH monitoring for MSG2 in slots/symbols that are configured as SBFD (e.g., in enhanced UL-DL TDD configuration signaled in SIB1).

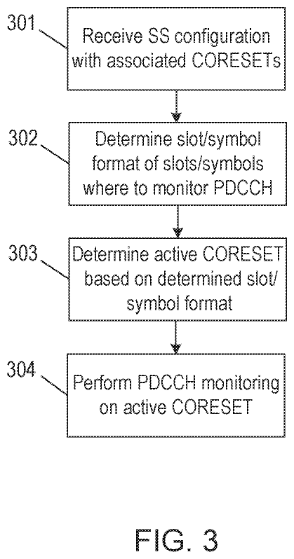

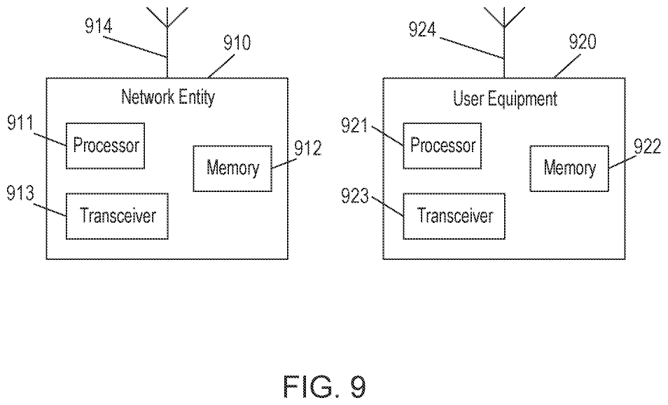

FIG. 3 illustrates an example of a flow diagram of a method that may be performed by a UE, such as UE 920 illustrated in FIG. 9, according to various example embodiments.

At 301, the method may include configuring the UE with multiple SSs and/or PDCCH CORESET configurations per SS, for example, by receiving an indication of at least one SS being associated with one or more CORESETs. For example, a SearchSpace information element (IE) may be received that includes a controlResourceSetId identifying at least one CORESET configuration. In example embodiments with more than one controlResourceSetId in the SearchSpace IE, one SS may be associated with more than one CORESET configuration.

The UE may receive the configuration from a base station, such as NE 910 illustrated in FIG. 9. Furthermore, each of the PDCCH CORESET configurations may be associated with a specific symbol/slot type.

In some example embodiments, the UE may be configured with at least 2 PDCCH CORESET configurations, with one of the PDCCH CORESET configurations being associated with DL-only slots/symbols (CORESET #A), and another one of the PDCCH CORESET configurations being associated with SBFD slots/symbols (CORESET #B). The UE may be configured with multiple CORESET IDs per SS. Each of the CORESET IDs in the SS IE may be associated with one of at least two slot/symbol formats (i.e., a first CORESET ID (CORESET #A) associated with DL-only slots/symbols, and a second control resource set ID (CORESET #B) associated with SBFD slots/symbols).

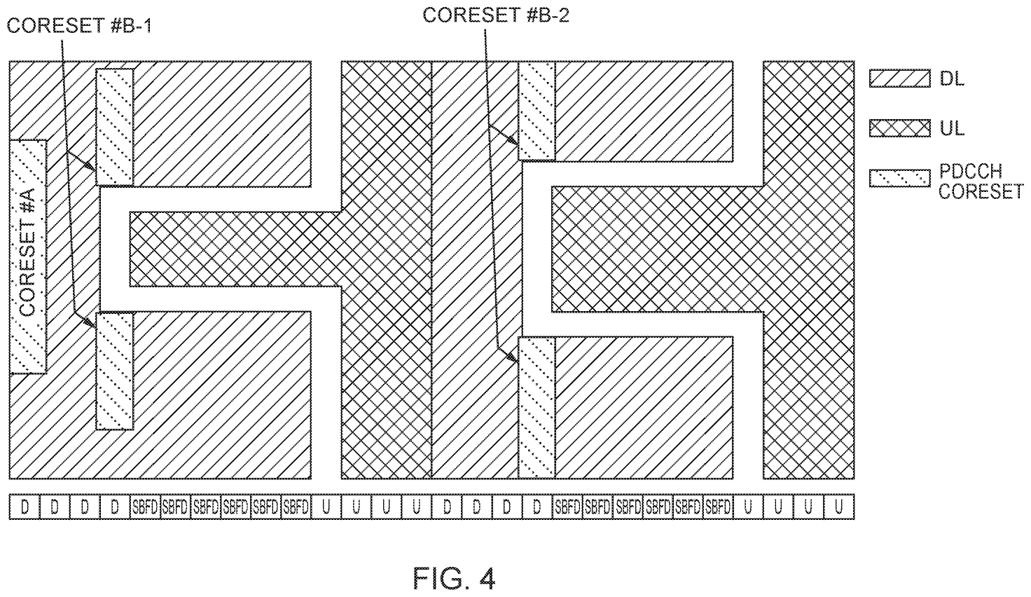

In the example embodiment illustrated in FIG. 4, where there are SBFD slots/symbols assigned with different DL-UL frequency partitioning, the UE may be configured by the base station with more than one PDCCH CORESET configuration to be used in SBFD slots/symbols, with each PDCCH CORESET configuration associated with different DL-UL frequency partitions (in this example, CORESET #B-1 and CORESET #B-2). The SS IE may include multiple CORESET IDs associated with different types of SBFD symbols/slots (e.g., one for each possible DL-UL frequency partition), CORESET #B-1, CORESET #B-2, and so on.

In various example embodiments, rather than configuring multiple PDCCH CORESET configurations (i.e., each PDCCH CORESET configuration associated with a specific slot/symbol type) per SS ID, multiple, overlapping SSs may be configured, with each SS associated with one PDCCH CORESET configuration. As an example, a specific association may be defined between each SS/corresponding CORESET and a specific slot/symbol type (e.g., DL only, SBFD, etc.).

In certain example embodiments, the association of the CORESET or SS to a specific slot/symbol type may be explicitly configured and/or implicitly determined by the UE according to DL/UL frequency partitioning in the symbol where the UE is performing PDCCH monitoring.

At 302, the method may include determining the symbol/slot format on the corresponding set of symbols before performing PDCCH monitoring on the set of symbols, such as the SS configurations received in 301. For example, the slot/symbol format may be determined based on traffic needs, such as whether data needs to be transmitted in DL or UL. The UE may receive signaling via any of SIB, dedicated RRC, and/or DCI (e.g., enhanced slot format indicator in DCI format 2_0). The UE may receive indications from the base station indicating whether the slot/symbol is a DL-only slot/symbol, an UL-only slot/symbol, or a SBFD slot/symbol. In particular, for SBFD slots/symbols, the UE may receive indications from the base station of actual UL-DL frequency partitioning of the SBFD slot/symbol (for example, which frequency resources within the slot/symbol are DL, and which are UL).

At 303, the method may include determining an active CORESET based upon the determined slot/symbol format. As used throughout this disclosure, an “active” or “valid” CORESET may refer to a CORESET where the UE may perform PDCCH monitoring according to a corresponding SS configuration; if a CORESET is invalid/inactive, the UE may not monitor PDCCH on that CORESET. For example, among the CORESET configurations associated with a SS and the corresponding set of symbols, the UE may determine the active/valid CORESET as the CORESET configuration associated with the corresponding symbol type. In an example with two CORESET configurations, if at least one of the symbols in the set of symbols is a SBFD symbol, the UE may determine the active/valid CORESET is the CORESET configuration associated with SBFD symbols. Alternatively, the UE may determine the active/valid CORESET is the CORESET configuration associated with DL-only symbols.

At 304, the method may include performing PDCCH monitoring on the set of slots/symbols associated with the active CORESET. Specifically, in the slots/symbols where the UE is configured to perform PDCCH monitoring based on the SS configuration, the UE may perform PDCCH monitoring using, among the multiple CORESET IDs configured for the corresponding SS, the CORESET configuration corresponding with the current slot or symbol type. For example, in the scenario illustrated in FIG. 4 with DL-only slots/symbols, the UE may perform PDCCH monitoring based on CORESET #A (i.e., DL-only slot if the corresponding slots/symbols were determined as DL-only slots/symbols at 302).

In SBFD slots/symbols with first DL-UL frequency partitioning, the UE may perform PDCCH monitoring based on CORESET #B-1 if the corresponding slots/symbols were determined as SBFD slots/symbols with first DL-UL frequency partitioning in 302. In SBFD slots/symbols with second DL-UL frequency partitioning, the UE may perform PDCCH monitoring based on CORESET #B-2 if the corresponding slots/symbols were determined as SBFD slots/symbols with second DL-UL frequency partitioning (if applicable) in 302.

In certain example embodiments, if the set of symbols on which the UE is configured to perform PDCCH monitoring include symbols of different type (e.g., DL and SBFD symbols), the UE may select the CORESET associated with the symbol type whose frequency resources overlap with the DL portion of the cell bandwidth in all symbols of the set of symbols (for example, the CORESET corresponding to SBFD symbols in the example above with 2 configured CORESETs per SS).

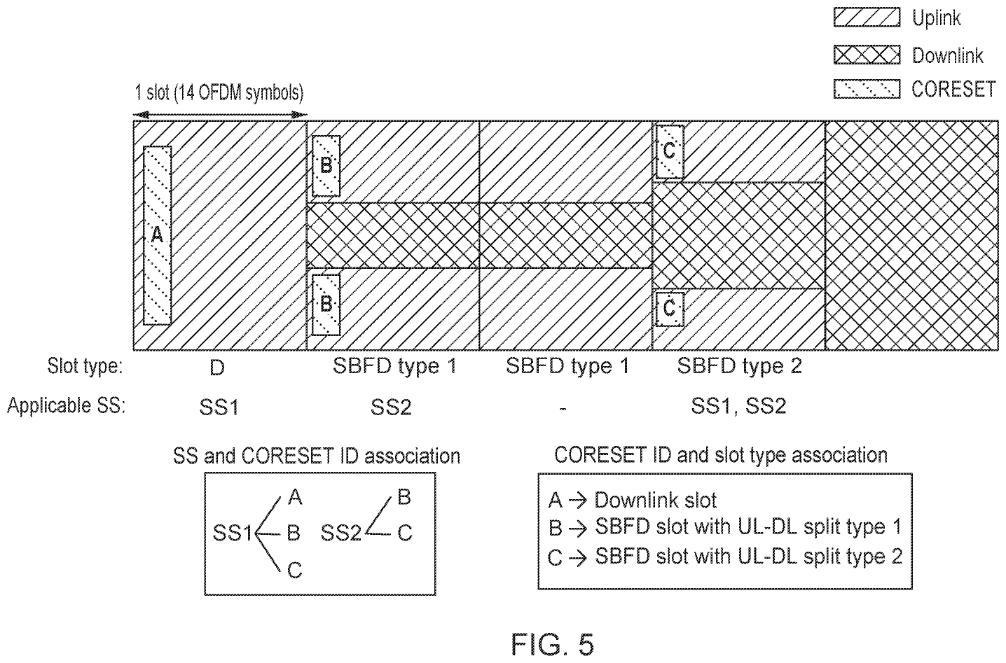

FIG. 5 illustrates exemplary relationships between CORESETs, SSs, and slot types according to various example embodiments discussed herein. The UE may be configured with two SSs: the first SS (SS1) may include a monitoring periodicity of 4 slots, while the second SS (SS2) may include a monitoring periodicity of 2 slots with each SS being configured with its own offset (e.g., configured via IE monitoringSlotPeriodicityAndOffset in each search space configuration). SS1 may be linked to three independent CORESETs, with each CORESET associated with a slot type (downlink slot, SBFD Type 1, SBFD Type 2). SS2 may be linked to only two of the CORESETs (i.e., those associated to SBFD Type 1 and SBFD Type 2 slots. The association granularity in time domain may also be in symbols, and the CORESET associated with one slot type in two different SSs may be different. In slots where the UE is supposed to perform PDCCH monitoring based on SS configuration, the UE may perform PDCCH monitoring on the corresponding CORESET derived from the current slot type and SS and CORESET ID association. In embodiments with multiple overlapping SSs, the UE may prioritize one SS over others in order to avoid exceeding a BD budget (e.g., a lower configuration index of the SS may correlate with a higher priority of the SS).

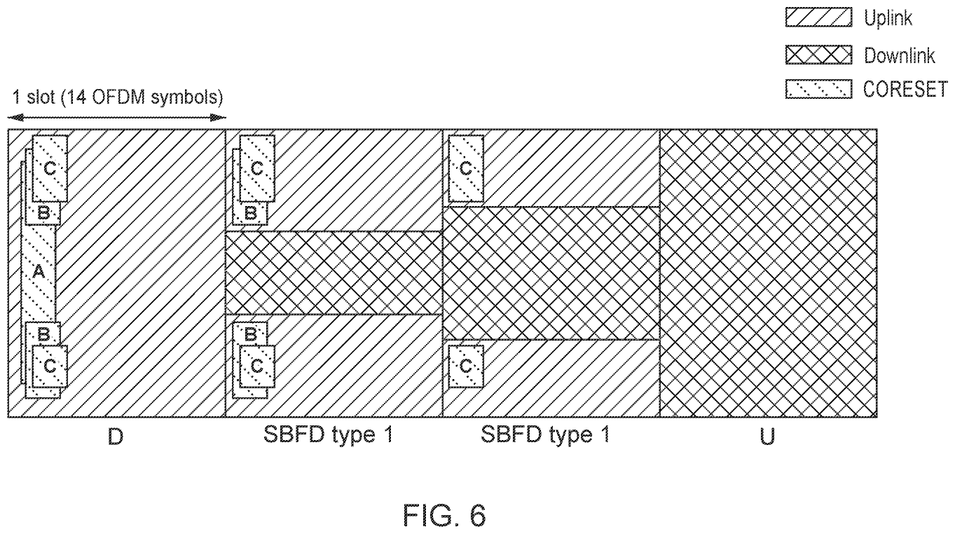

In various example embodiments, the UE may receive one or more CORESETs, and rules may define how the UE shall determine which CORESET(s) are valid for a specific set of symbols/slots depending on the PRB split. For example, CORESET(s) partly or fully overlapping with UL PRBs may be defined as “invalid” (i.e., not used for monitoring PDCCH assignments), as illustrated in FIG. 6, where 3 CORESETs are defined. However, in some symbols/slots, only a subset of those symbols/slots may be used for PDCCH monitoring. Similarly, for multiple “valid” CORESETs (e.g., in the first slot on left side of FIG. 6), the SS configuration (and association between SS and CORESET) may define which CORESETs to use for PDCCH monitoring. Alternatively, only the CORESET with a lowest configuration index (among the “valid” CORESETs) may be considered for PDCCH monitoring (i.e., CORESETs A, B, and C from slots left to right in FIG. 6).

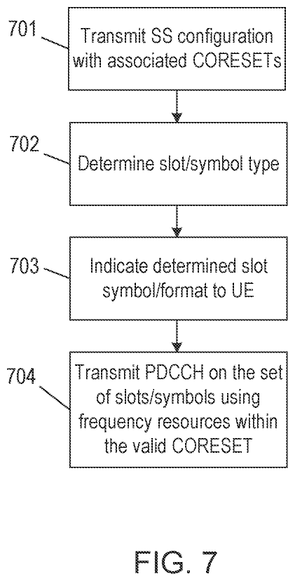

FIG. 7 illustrates an example of a flow diagram of a method that may be performed by a NE, such as NE 910 illustrated in FIG. 9, according to various example embodiments.

At 701, the method may include configuring a UE, such as UE 920 illustrated in FIG. 9, with multiple SSs and/or PDCCH CORESET configurations per SS, for example, by transmitting an indication of at least one SS being associated with one or more CORESETs. For example, a SearchSpace IE may be transmitted that includes a controlResourceSetId identifying at least one CORESET configuration. In example embodiments with more than one controlResourceSetId in the SearchSpace IE, one SS may be associated with more than one CORESET configuration. Furthermore, each of the PDCCH CORESET configurations may be associated with a specific symbol/slot type.

In some example embodiments, the NE may configure the UE with at least 2 PDCCH CORESET configurations, with one of the PDCCH CORESET configurations being associated with DL-only slots/symbols (CORESET #A), and another one of the PDCCH CORESET configurations being associated with SBFD slots/symbols (CORESET #B). The NE may configure the UE with multiple CORESET IDs per SS. Each of the CORESET IDs in the SS IE may be associated with one of at least two slot/symbol formats (i.e., a first CORESET ID (CORESET #A) associated with DL-only slots/symbols, and a second control resource set ID (CORESET #B) associated with SBFD slots/symbols).

In the example embodiment illustrated in FIG. 4, where there are SBFD

slots/symbols assigned with different DL-UL frequency partitioning, the NE may configure the UE with more than one PDCCH CORESET configuration to be used in SBFD slots/symbols, with each PDCCH CORESET configuration associated with different DL-UL frequency partitions (in this example, CORESET #B-1 and CORESET #B-2). The SS IE may include multiple CORESET IDs associated with different types of SBFD symbols/slots (e.g., one for each possible DL-UL frequency partition), CORESET #B-1, CORESET #B-2, and so on.

In various example embodiments, rather than configuring multiple PDCCH CORESET configurations (i.e., each PDCCH CORESET configuration associated with a specific slot/symbol type) per SS ID, multiple, overlapping SSs may be configured, with each SS associated with one PDCCH CORESET configuration. As an example, a specific association may be defined between each SS/corresponding CORESET and a specific slot/symbol type (e.g., DL only, SBFD, etc.).

In certain example embodiments, the association of the CORESET or SS to a specific slot/symbol type may be explicitly configured according to DL/UL frequency partitioning in the symbol where the UE is performing PDCCH monitoring.

At 702, the method may include determining the symbol/slot format on the corresponding set of symbols before performing PDCCH transmission on the set of symbols, such as the SS configurations transmitted at 701. For example, the slot/symbol format may be determined based on traffic needs, such as whether data needs to be transmitted in DL or UL. The NE may transmit signaling to the UE via any of SIB, dedicated RRC, and/or DCI (e.g., enhanced slot format indicator in DCI format 2_0). The NE may transmit indications to the UE indicating whether the slot/symbol is a DL-only slot/symbol, an UL-only slot/symbol, or a SBFD slot/symbol. In particular, for SBFD slots/symbols, the NE may transmit indications to the UE of actual UL-DL frequency partitioning of the SBFD slot/symbol (for example, which frequency resources within the slot/symbol are DL, and which are UL).

At 703, the method may include indicating the determined slot symbol/format to the UE.

At 704, the method may include transmitting PDCCH on the set of slots/symbols using frequency resources within the valid CORESET. Specifically, in the slots/symbols where the NE configured the UE to perform PDCCH monitoring based on the SS configuration, the NE may transmit PDCCH using, among the multiple CORESET IDs configured for the corresponding SS, the CORESET configuration corresponding with the current slot or symbol type. For example, in the scenario illustrated in FIG. 4 with DL-only slots/symbols, the NE may transmit PDCCH on CORESET #A (i.e., the CORESET associated with DL-only slots/symbols) if the corresponding slots/symbols are determined as DL-only slots/symbols at 702.

In SBFD slots/symbols with first DL-UL frequency partitioning, the NE may transmit PDCCH based on CORESET #B-1 if the corresponding slots/symbols were determined as SBFD slots/symbols with first DL-UL frequency partitioning. In SBFD slots/symbols with second DL-UL frequency partitioning, the NE may transmit PDCCH monitoring based on CORESET #B-2 if the corresponding slots/symbols were determined as SBFD slots/symbols with second DL-UL frequency partitioning (if applicable) at 702.

FIG. 5 illustrates exemplary relationships between CORESETs, SSs, and slot types according to various example embodiments discussed herein. The UE may be configured with two SSs: the first SS (SS1) may include a monitoring periodicity of 4 slots, while the second SS (SS2) may include a monitoring periodicity of 2 slots with each SS being configured with its own offset (e.g., configured via IE monitoringSlotPeriodicityAndOffset in each search space configuration). SS1 may be linked to three independent CORESETs, with each CORESET associated with a slot type (downlink slot, SBFD Type 1, SBFD Type 2). SS2 may be linked to only two of the CORESETs (i.e., those associated to SBFD Type 1 and SBFD Type 2 slots. The association granularity in time domain may also be in symbols, and the CORESET associated with one slot type in two different SSs may be different. In slots where the UE is supposed to perform PDCCH monitoring based on SS configuration, the UE may perform PDCCH monitoring on the corresponding CORESET derived from the current slot type and SS and CORESET ID association. In embodiments with multiple overlapping SSs, the UE may prioritize one SS over others in order to avoid exceeding a BD budget (e.g., a lower configuration index of the SS may correlate with a higher priority of the SS).

In various example embodiments, the NE may transmit one or more CORESETs, and rules may define how the UE shall determine which CORESET(s) are valid for a specific set of symbols/slots depending on the PRB split. For example, CORESET(s) partly or fully overlapping with UL PRBs may be defined as “invalid” (i.e., not used for monitoring PDCCH assignments), as illustrated in FIG. 6, where 3 CORESETs are defined. However, in some symbols/slots, only a subset of those symbols/slots may be used for PDCCH monitoring. Similarly, for multiple “valid” CORESETs (e.g., in the first slot on left side of FIG. 6), the SS configuration (and association between SS and CORESET) may define which CORESETs to use for PDCCH monitoring. Alternatively, only the CORESET with a lowest configuration index (among the “valid” CORESETs) may be considered for PDCCH monitoring (i.e., CORESETs A, B, and C from slots left to right in FIG. 6).

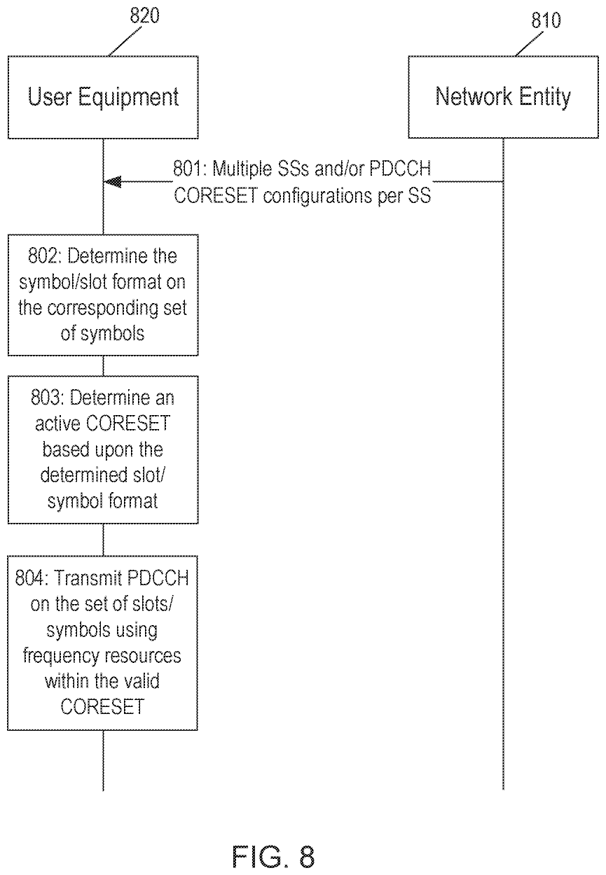

FIG. 8 illustrates an example of a signaling diagram depicting for enhancing dynamic CORESET adaptation with limited or no control channel overhead. NE 810 and UE 820 may be similar to NE 910 and UE 920, as illustrated in FIG. 9, according to certain example embodiments.

At 801, NE 810 may configure UE 820 with multiple SSs and/or PDCCH CORESET configurations per SS, for example, by transmitting an indication of at least one SS being associated with one or more CORESETs. For example, a SearchSpace information element (IE) may be received that includes a controlResourceSetId identifying at least one CORESET configuration. In example embodiments with more than one controlResourceSetId in the SearchSpace IE, one SS may be associated with more than one CORESET configuration. Furthermore, each of the PDCCH CORESET configurations may be associated with a specific symbol/slot type.

In some example embodiments, UE 820 may be configured with at least 2 PDCCH CORESET configurations, with one of the PDCCH CORESET configurations being associated with DL-only slots/symbols (CORESET #A), and another one of the PDCCH CORESET configurations being associated with SBFD slots/symbols (CORESET #B). UE 820 may be configured with multiple CORESET IDs per SS. Each of the CORESET IDs in the SS IE may be associated with one of at least two slot/symbol formats (i.e., a first CORESET ID (CORESET #A) associated with DL-only slots/symbols, and a second control resource set ID (CORESET #B) associated with SBFD slots/symbols).

In the example embodiment illustrated in FIG. 4, where there are SBFD slots/symbols assigned with different DL-UL frequency partitioning, CE 820 may be configured by NE 810 with more than one PDCCH CORESET configuration to be used in SBFD slots/symbols, with each PDCCH CORESET configuration associated with different DL-UL frequency partitions (in this example, CORESET #B-1 and CORESET #B-2). The SS IE may include multiple CORESET IDs associated with different types of SBFD symbols/slots (e.g., one for each possible DL-UL frequency partition), CORESET #B-1, CORESET #B-2, and so on.

In various example embodiments, rather than configuring multiple PDCCH CORESET configurations (i.e., each PDCCH CORESET configuration associated with a specific slot/symbol type) per SS ID, multiple, overlapping SSs may be configured, with each SS associated with one PDCCH CORESET configuration. As an example, a specific association may be defined between each SS/corresponding CORESET and a specific slot/symbol type (e.g., DL only, SBFD, etc.).

In certain example embodiments, the association of the CORESET or SS to a specific slot/symbol type may be explicitly configured and/or implicitly determined by UE 820 according to DL/UL frequency partitioning in the symbol where UE 820 is performing PDCCH monitoring.

At 802, UE 820 may determine the symbol/slot format on the corresponding set of symbols before performing PDCCH monitoring on the set of symbols, such as the SS configurations received in 801. For example, the slot/symbol format may be determined based on traffic needs, such as whether data needs to be transmitted in DL or UL. UE 820 may receive signaling via any of SIB, dedicated RRC, and/or DCI (e.g., enhanced slot format indicator in DCI format 2_0). UE 820 may receive indications from NE 810 indicating whether the slot/symbol is a DL-only slot/symbol, an UL-only slot/symbol, or a SBFD slot/symbol. In particular, for SBFD slots/symbols, UE 820 may receive indications from the base station of actual UL-DL frequency partitioning of the SBFD slot/symbol (for example, which frequency resources within the slot/symbol are DL, and which are UL).

At 803, UE 820 may determine an active CORESET based upon the determined slot/symbol format. As used throughout this disclosure, an “active” or “valid” CORESET may refer to a CORESET where UE 820 may perform PDCCH monitoring according to a corresponding SS configuration; if a CORESET is invalid/inactive, UE 820 may not monitor PDCCH on that CORESET. For example, among the CORESET configurations associated with a SS and the corresponding set of symbols, UE 820 may determine the active/valid CORESET as the CORESET configuration associated with the corresponding symbol type. In an example with two CORESET configurations, if at least one of the symbols in the set of symbols is a SBFD symbol, UE 820 may determine the active/valid CORESET is the CORESET configuration associated with SBFD symbols. Alternatively, UE 820 may determine the active/valid CORESET is the CORESET configuration associated with DL-only symbols.

At 804, UE 820 may transmit PDCCH on the set of slots/symbols using frequency resources within the valid CORESET. Specifically, in the slots/symbols where UE 820 is configured to perform PDCCH monitoring based on the SS configuration, UE 820 may perform PDCCH monitoring using, among the multiple CORESET IDs configured for the corresponding SS, the CORESET configuration corresponding with the current slot or symbol type. For example, in the scenario illustrated in FIG. 4 with DL-only slots/symbols, UE 820 may perform PDCCH monitoring based on CORESET #A (i.e., DL-only slot if the corresponding slots/symbols were determined as DL-only slots/symbols at 802).

In SBFD slots/symbols with first DL-UL frequency partitioning, UE 820 may perform PDCCH monitoring based on CORESET #B-1 if the corresponding slots/symbols were determined as SBFD slots/symbols with first DL-UL frequency partitioning in 802. In SBFD slots/symbols with second DL-UL frequency partitioning, UE 820 may perform PDCCH monitoring based on CORESET #B-2 if the corresponding slots/symbols were determined as SBFD slots/symbols with second DL-UL frequency partitioning (if applicable) in 802.

In certain example embodiments, if the set of symbols on which the UE is configured to perform PDCCH monitoring include symbols of different type (e.g., DL and SBFD symbols), UE 820 may select the CORESET associated with the symbol type whose frequency resources overlap with the DL portion of the cell bandwidth in all symbols of the set of symbols (for example, the CORESET corresponding to SBFD symbols in the example above with 2 configured CORESETs per SS).

FIG. 5 illustrates exemplary relationships between CORESETs, SSs, and slot types according to various example embodiments discussed herein. The UE may be configured with two SSs: the first SS (SS1) may include a monitoring periodicity of 4 slots, while the second SS (SS2) may include a monitoring periodicity of 2 slots with each SS being configured with its own offset (e.g., configured via IE monitoringSlotPeriodicityAndOffset in each search space configuration). SS1 may be linked to three independent CORESETs, with each CORESET associated with a slot type (downlink slot, SBFD Type 1, SBFD Type 2). SS2 may be linked to only two of the CORESETs (i.e., those associated to SBFD Type 1 and SBFD Type 2 slots. The association granularity in time domain may also be in symbols, and the CORESET associated with one slot type in two different SSs may be different. In slots where the UE is supposed to perform PDCCH monitoring based on SS configuration, the UE may perform PDCCH monitoring on the corresponding CORESET derived from the current slot type and SS and CORESET ID association. In embodiments with multiple overlapping SSs, the UE may prioritize one SS over others in order to avoid exceeding a BD budget (e.g., a lower configuration index of the SS may correlate with a higher priority of the SS).

In various example embodiments, UE 820 may receive one or more CORESETs, and rules may define how UE 820 shall determine which CORESET(s) are valid for a specific set of symbols/slots depending on the PRB split. For example, CORESET(s) partly or fully overlapping with UL PRBs may be defined as “invalid” (i.e., not used for monitoring PDCCH assignments), as illustrated in FIG. 6, where 3 CORESETs are defined. However, in some symbols/slots, only a subset of those symbols/slots may be used for PDCCH monitoring. Similarly, for multiple “valid” CORESETs (e.g., in the first slot on left side of FIG. 6), the SS configuration (and association between SS and CORESET) may define which CORESETs to use for PDCCH monitoring. Alternatively, only the CORESET with a lowest configuration index (among the “valid” CORESETs) may be considered for PDCCH monitoring (i.e., CORESETs A, B, and C from slots left to right in FIG. 6).

FIG. 9 illustrates an example of a system according to certain example embodiments. In one example embodiment, a system may include multiple devices, such as, for example, NE 10 and/or UE 920.

NE 910 may be one or more of a base station, such as an eNB or gNB, a serving gateway, a server, and/or any other access node or combination thereof.

NE 910 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 920 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 910 and/or UE 920 may be one or more of a citizens broadband radio service device (CBSD).

NE 910 and/or UE 920 may include at least one processor, respectively indicated as 911 and 921. Processors 911 and 921 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 912 and 922. The memory may be fixed or removable. The memory may include computer program instructions or computer code contained therein. Memories 912 and 922 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 911 and 921, memories 912 and 922, and any subset thereof, may be configured to provide means corresponding to the various blocks of FIGS. 4-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 9, transceivers 913 and 923 may be provided, and one or more devices may also include at least one antenna, respectively illustrated as 914 and 924. The device may have many antennas, such as an array of antennas configured for multiple input multiple output (MIMO) communications, or multiple antennas for multiple RATs. Other configurations of these devices, for example, may be provided. Transceivers 913 and 923 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 4-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 4-7. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

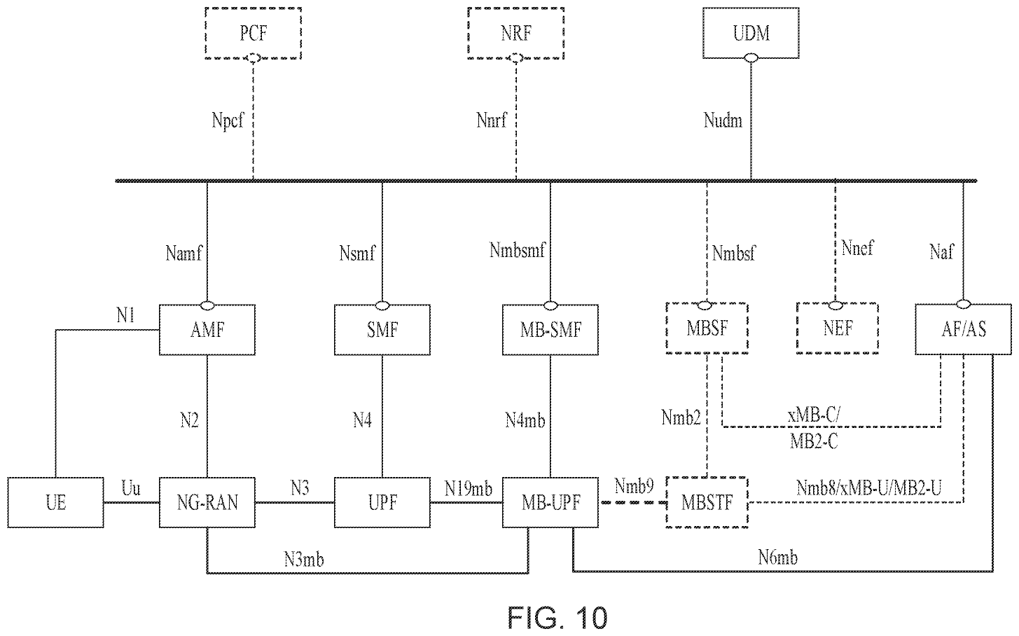

FIG. 10 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 10 may be similar to NE 910 and UE 920, respectively. The user plane function (UPF) may provide services such as intra-RAT and inter-RAT mobility, routing and forwarding of data packets, inspection of packets, user plane quality of service (QOS) processing, buffering of downlink packets, and/or triggering of downlink data notifications. The application function (AF) may primarily interface with the core network to facilitate application usage of traffic routing and interact with the policy framework.

According to certain example embodiments, processors 911 and 921, and memories 912 and 922, may be included in or may form a part of processing circuitry or control circuitry. In addition, in some example embodiments, transceivers 913 and 923 may be included in or may form a part of transceiving circuitry.

In some example embodiments, an apparatus (e.g., NE 910 and/or UE 920) may include means for performing a method, a process, or any of the variants discussed herein. Examples of the means may include one or more processors, memory, controllers, transmitters, receivers, and/or computer program code for causing the performance of the operations.

In various example embodiments, apparatus 920 may be controlled by memory 922 and processor 921 to receive a plurality of PDCCH CORESET configurations associated with at least one SS, determine at least one of the PDCCH CORESET configurations is associated with a symbol or slot format from a corresponding set of symbols, and perform PDCCH monitoring on an active CORESET configuration associated with the set of determined slots or symbols.

In various example embodiments, apparatus 910 may be controlled by memory 912 and processor 911 to transmit a plurality of PDCCH CORESET configurations associated with a SS to a UE, and transmit control information to the UE on a PDCCH on a set of slots or symbols and on a set of frequency resources within an active CORESET configuration.

Certain example embodiments may be directed to an apparatus that includes means for performing any of the methods described herein including, for example, means for receiving a plurality of PDCCH CORESET configurations associated with at least one SS, determining at least one of the PDCCH CORESET configurations is associated with a symbol or slot format from a corresponding set of symbols, and performing PDCCH monitoring on an active CORESET configuration associated with the set of determined slots or symbols.

Certain example embodiments may be directed to an apparatus that includes means for performing any of the methods described herein including, for example, means for transmitting a plurality of PDCCH CORESET configurations associated with a SS to a UE, and means for transmitting control information to the UE on a PDCCH on a set of slots or symbols and on a set of frequency resources within an active CORESET configuration.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP Third Generation Partnership Project
5G Fifth Generation
5GC Fifth Generation Core
5GS Fifth Generation System
6G Sixth Generation
AL Aggregation Level
AMF Access and Mobility Management Function
ASIC Application Specific Integrated Circuit
BD Blind Decode
BS Base Station
BW Bandwidth
BWP Bandwidth Part
CBSD Citizens Broadband Radio Service Device
CE Control Element
CN Core Network
CORESET Control Resource Set
CPU Central Processing Unit
DCI Downlink Control Information
DL Downlink
eIMTA Enhanced Interference Mitigation and Traffic Adaptation
eMBB Enhanced Mobile Broadband
eMTC Enhanced Machine Type Communication
eNB Evolved Node B
eOLLA Enhanced Outer Loop Link Adaptation
EPS Evolved Packet System
FDD Frequency Division Duplex
FDU Flexible Duplexing
FR Frequency Range FR
gNB Next generation Node B
GPS Global Positioning System
HDD Hard Disk Drive
IE Information Element
IoT Internet of Things
LTE Long-Term Evolution
LTE-A Long-Term Evolution Advanced
MAC Medium Access Control
MEMS Micro Electrical Mechanical System
MME Mobility Management Entity
mMTC Massive Machine Type Communication
MSG Message
MTC Machine Type Communication
NAS Non-Access Stratum
NE Network Entity
NG Next Generation
NG-eNB Next Generation Evolved Node B
NG-RAN Next Generation Radio Access Network
NR New Radio
NR-U New Radio Unlicensed
PDA Personal Digital Assistance
PDCCH Physical Downlink Control Channel
PDSCH Physical Downlink Shared Channel
PRB Physical Resource Block
RA Random Access
RACH Random Access Channel
RAM Random Access Memory
RAN Radio Access Network
RAT Radio Access Technology
RB Resource Block
RE Resource Element
RF Radio Frequency
RRC Radio Resource Control
RS Reference Signal
RX Receive
SBFD Sub-Band Full Duplex
SIB System Information Block
SMF Session Management Function
SS Search Space
TDD Time Division Duplex
TX Transmission
UE User Equipment
UL Uplink
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network
xDD Cross-Division Duplexing

1. A method, comprising:
receiving, by a user equipment, a plurality of physical downlink control channel control resource set configurations associated with at least one search space;
determining, by the user equipment, at least one of the physical downlink control channel control resource set configurations is associated with a symbol or slot format from a corresponding set of symbols; and
performing, by the user equipment, physical downlink control channel monitoring on an active control resource set configuration associated with the set of determined slots or symbols.

2. The method of claim 1, further comprising:
determining, by the user equipment, an active control resource set configuration based upon the determined slot or symbol format.

3. The method of claim 1, wherein the determined symbol or slot format is received by any of system information blocks, dedicated radio resource control, and downlink control information.

4. The method of claim 1, wherein each of the physical downlink control channel control resource set configurations are associated with a specific symbol or slot type.

5. The method of claim 1, wherein each search space is associated with a plurality of the control resource set configurations.

6. The method of claim 1, further comprising:
receiving, by the user equipment, a plurality of overlapping search spaces, wherein each search space is associated with one physical downlink control channel control resource set configuration.

7. The method of claim 1, wherein an association between a physical downlink control channel control resource set configuration or search space and a specific slot or symbol type is determined according to downlink/uplink frequency partitioning in the slot or symbol where the user equipment is performing physical downlink control channel monitoring.

8. The method of claim 1, further comprising:
receiving, by the user equipment, data indicating whether the determined symbol or slot format is a downlink-only slot/symbol, uplink-only slot/symbol, or a sub-band full duplex slot/symbol.

9-15. (canceled)

16. An apparatus, comprising:
at least one processor; and
at least one memory including computer program code,
wherein the at least one memory and the computer program code are configured to, with the at least one processor, cause the apparatus at least to:
receive a plurality of physical downlink control channel control resource set configurations associated with at least one search space;
determine at least one of the physical downlink control channel control resource set configurations is associated with a symbol or slot format from a corresponding set of symbols; and
perform physical downlink control channel monitoring on an active control resource set configuration associated with the set of determined slots or symbols.

17. The apparatus of claim 16, wherein the at least one memory and the computer program code are further configured to, with the at least one processor, cause the apparatus at least to:
determine an active control resource set configuration based upon the determined slot or symbol format.

18. The apparatus of claim 16, wherein the determined symbol or slot format is received by any of system information blocks, dedicated radio resource control, and downlink control information.

19. The apparatus of claim 16, wherein each of the physical downlink control channel control resource set configurations are associated with a specific symbol or slot type.

20. The apparatus of claim 16, wherein each search space is associated with a plurality of the control resource set configurations.

21. The apparatus of claim 16, wherein the at least one memory and the computer program code are further configured to, with the at least one processor, cause the apparatus at least to:
receive a plurality of overlapping search spaces, wherein each search space is associated with one physical downlink control channel control resource set configuration.

22. The apparatus of claim 16, wherein an association between a physical downlink control channel control resource set configuration or search space and a specific slot or symbol type is determined according to downlink/uplink frequency partitioning in the slot or symbol where the user equipment is performing physical downlink control channel monitoring.

23. The apparatus of claim 16, wherein the at least one memory and the computer program code are further configured to, with the at least one processor, cause the apparatus at least to:
receive data indicating whether the determined symbol or slot format is a downlink-only slot/symbol, uplink-only slot/symbol, or a sub-band full duplex slot/symbol.

24. An apparatus, comprising:
at least one processor; and
at least one memory including computer program code,
wherein the at least one memory and the computer program code are configured to, with the at least one processor, cause the apparatus at least to:
transmit a plurality of physical downlink control channel control resource set configurations associated with a search space to a user equipment; and
transmit control information to the user equipment on a physical downlink control channel on a set of slots or symbols and on a set of frequency resources within an active control resource set configuration.

25. The apparatus of claim 24, wherein the at least one memory and the computer program code are further configured to, with the at least one processor, cause the apparatus at least to:
transmit data indicating whether a determined symbol or slot format is a downlink-only slot/symbol, uplink-only slot/symbol, or a sub-band full duplex slot/symbol.

26-28. (canceled)

29. The apparatus of claim 24, wherein the at least one memory and the computer program code are further configured to, with the at least one processor, cause the apparatus at least to:
transmitting, by the network entity, a plurality of overlapping search spaces, wherein each search space is associated with one physical downlink control channel control resource set configuration.

30-46. (canceled)

47. An apparatus comprising circuitry configured to perform a method according to claim 1.

48. (canceled)
